(19) United States
(12) Patent Application Publication
(10) Pub. No.: US 2016/0020725 A1
(43) Pub. Date: Jan. 21, 2016

(54) SUN-TRACKING PHOTOVOLTAIC POWER GENERATION SYSTEM

(71) Applicant: ELM Inc., Kagoshima (JP)

(72) Inventors: Takakazu MIYAHARA, Kagoshima (JP); Terumasa MIYAHARA, Kagoshima (JP)

(21) Appl. No.: 14/870,221

(22) Filed: Sep. 30, 2015

Related U.S. Application Data
(63) Continuation of application No. PCT/JP2014/059950, filed on Apr. 4, 2014.

(30) Foreign Application Priority Data
Apr. 4, 2013 (JP) 2013-078481

(51) Int. Cl. H02S 20/32

(52) U.S. Cl. CPC H02S 20/32

(57) ABSTRACT

A sun-tracking photovoltaic power generation system with a rotating a base having a plurality of photovoltaic power generation panels loaded thereon closely to each other following changes in the solar azimuth angle. A plurality of rails are concentrically laid on an undersurface of the base and wheels are provided to a stand closer to the ground. As a result, it is easier to support the wheels on the same horizontal plane than laying the rails horizontally on a large installation space. Therefore, the construction cost can be reduced and the construction period can be shortened, thereby achieving a large sun-tracking photovoltaic power generation system. Also, because the base is concentrically reinforced by the plurality of rails, the base can be formed by combining, for example, metal L angles, so that a base with a large area can be made light weight at a low cost.

### TECHNICAL FIELD

The present invention relates to a photovoltaic power generation system, and particularly relates to one tracking the azimuth (east-west) movement of the sun.

### BACKGROUND ART

In recent years, there has been a growing need for new power sources using renewable energy in order to reduce CO₂ emissions, discourage nuclear power generation, and the like. Among such new power sources, photovoltaic power generation is attracting attention for the improved electric generation efficiency and the reduced cost of a photovoltaic power generation panel. Photovoltaic power generation is performed by converting energy of sunlight entering a photovoltaic power generation panel to electric energy. The photoelectric conversion efficiency is shown by the ratio of electric energy which can be practically taken out from a photovoltaic power generation panel 10 relative to the energy of sunlight 20 perpendicularly entering the panel 10, as shown in FIG. 12A.

When the electric generation efficiency (photoelectric conversion efficiency) of the photovoltaic power generation panel 10 is EF, the average energy of the sunlight 20 entering the photovoltaic power generation panel 10 is ES, and the time during which the panel 10 is exposed to the sunlight 20 is T, the calculated output energy P₀ of the photovoltaic power generation panel 10 is as follows:

P₀=ES×EF×T

However, the output energy P₀ can be obtained only when the sun is directly opposite to the photovoltaic power generation panel 10. In reality, with the incident angle of the sunlight 20 changing every moment, the output energy P₀ obtained is equal to or less than half of that in the above equation on average if the photovoltaic power generation panel 10 is left (fixed). The incident angle is expressed using two angles of an azimuth angle and an elevation/depression angle.

Specifically, in a case of an installation of typical photovoltaic power generation panel, which means, a photovoltaic power generation system of fixed type installed, for example, on a roof of a house, that is, not sun-tracking type, the incident angle of the sunlight 20 entering the photovoltaic power generation panel 10 varies greatly with the season and the time. For example, when the incident angle is 45 degrees as shown in FIG. 12B, the energy of the sunlight 20 which is entering the photovoltaic power generation panel 10 is cos 45°, that is, 0.707 of the energy at the direct opposition. Moreover, when the incident angle is 60 degrees as shown in FIG. 12C, the energy is reduced to cos 60°, that is, 0.5 of the energy at the direct opposition, which means that the energy of the sunlight 20 is reduced to the half. Furthermore, the greater the incident angle of the sunlight 20 to the photovoltaic power generation panel 10 is and the more obliquely the sunlight 20 tries to enter, the more proportion of the light is reflected on a glass surface of the photovoltaic power generation panel 10, considerably reducing the energy of the sunlight 20 actually enters the photovoltaic power generation panel 10 relative to the value above.

So, in order to prevent such reduction of the incident energy of the photovoltaic power generation panel 10, that is, the electric generation efficiency EF, the photovoltaic power generation panel 10 may be driven such that the panel 10 is directly opposite to the sun. For example, when the incident angle of the sunlight 20 is 45 degrees (relative to a normal line of the panel) as in FIG. 12B, if the photovoltaic power generation panel 10 is rotated by 45 degrees so that the panel 10 is directly opposite to the sun as in FIG. 13A, the sunlight 20 enters the panel substantially by 100% while suppressing reflection on the glass surface, thereby maximizing the power generation amount. Similarly, even when the incident angle is 60 degrees as in FIG. 12C, if the photovoltaic power generation panel 10 is rotated by 60 degrees as in FIG. 13B, 100% of the energy of the sunlight 20 enters the photovoltaic power generation panel 10, thereby maximizing the power generation amount. A sun-tracking photovoltaic power generation device has been proposed which is configured to solve the problem of the reduction in output by rotating the photovoltaic power generation panel 10 as described above (for example, see Patent Literature 1).

In such a conventionally proposed photovoltaic power generation system, it seems that, when using a plurality of photovoltaic power generation panels, the power generation amount is increased by rotating each photovoltaic power generation panel. However, as shown in FIG. 14, the more greatly each photovoltaic power generation panel rotates from a state where all the panels are arranged flush to each other, the more a photovoltaic power generation panel relatively close to the sun casts a shadow on a photovoltaic power generation panel right behind relatively far from the sun. Accordingly, the photovoltaic power generation panels need to be installed with considerable space therebetween to reduce the impact of shadow. Thus, in the case of a photovoltaic power generation device which uses a plurality of photovoltaic power generation panels and rotates the panels separately, the number (area) of photovoltaic power generation panels which can be installed in the same site area decreases compared to a photovoltaic power generation device of fixed type. As a result, the power generation per unit site area does not increase so much even if the photovoltaic power generation panel is divided into a plurality of panels.

In addition, the foregoing photovoltaic power generation system needs a tracking device for each or each several photovoltaic power generation panels. Thus, the cost of the tracking devices and the energy for tracking mount up, leading to less economic effects by the use of solar energy. As a result, the foregoing photovoltaic power generation system is currently used only for small-scale power generation with limited installation area such as on a roof of a building.

Here, two angles of an azimuth angle and an elevation/depression angle are needed to correctly express an angle at which the sunlight 20 enters the photovoltaic power generation panel 10. However, because the azimuth angle varying within a day has a greater effect on the electric generation efficiency than the elevation/depression angle varying with the season, a following description of FIGS. 12A to 12C, FIGS. 13A and 13B, FIG. 14, and FIG. 15 will be given mainly assuming changes in the azimuth angle.

Then, it is conceivable to install a plurality of photovoltaic power generation panels on a common base while taking the impact of shadow into consideration, and rotate the base about a vertical axis, to thereby track changes of the solar azimuth angle. In this case, a device is conceivable in which while foundations and pavement are constructed on the ground of an installation site to prepare a stand, on which a circular rail is laid, a plurality of wheels are provided which can roll on the rail on the base having the photovoltaic power generation panels loaded thereon, allowing the device to track the sun by rotating the base on the rail. Such a device can bear a heavy load by concentrically providing a plurality of the rails and also providing a plurality of the wheels. This allows a sun-tracking photovoltaic power generation system using a large photovoltaic power generation panel with a large total panel area. Also, a common tracking device is used for a number of photovoltaic power generation panels, reducing the device cost of the tracking device and the energy for tracking. The present applicant has filed an application on such a sun-tracking photovoltaic power generation system as Japanese Patent Laid-Open No. 2013-74037.

Thus, due to the invention of the Japanese Patent Laid-Open No. 2013-74037, even a photovoltaic power generation panel with a heavy load can form a sun-tracking photovoltaic power generation system. However, because the system is large, the rail has to be raid over a large area, and it is difficult to lay the rail horizontally along the entire length of the rail with high precision. In other words, the system requires a high-precision construction. Therefore, although the costs for the panel and tracking are kept low as described above, in contrast, the construction cost mounts up and also it is difficult to shorten the construction period.

### Patent Literature 1: Japanese Patent Laid-Open No. 2007-258357

### SUMMARY OF INVENTION

Then, an object of the present invention is to provide a technique which can reduce the construction cost and shorten the construction period in a large sun-tracking photovoltaic power generation system.

In order to achieve the above object, a sun-tracking photovoltaic power generation system according to an aspect of the present invention is based on further improvements on the invention of the Japanese Patent Laid-Open No. 2013-74037, and in a sun-tracking photovoltaic power generation system configured to rotate by rotating means a base having a plurality of photovoltaic power generation panels loaded thereon closely to each other such that the photovoltaic power generation panels are directly opposite to the sun at flat surfaces, the rotating means includes a plurality of rails to be laid concentrically on an undersurface of the base having the photovoltaic power generation panels loaded thereon, a plurality of wheels on which the rails are to be placed and supported, wheel supporting means for supporting the wheels on a stand provided at an installation site, and driving means for rotating the base on the wheels, and the base is composed of combined L angles in a grid pattern and concentrically reinforced by the plurality of rails.

According to the above configuration, the plurality of rails are provided on the undersurface of the base having the plurality of photovoltaic power generation panels loaded thereon, and the wheels on which the rails are placed are provided on a top surface of the stand at an installation site. As a result, it is easier to carry out construction by providing the wheels as arranged horizontally to the same height than by horizontally laying the entire length of the rails. Therefore, the construction cost can be reduced and the construction period can be shortened, thereby facilitating the spread of large sun-tracking photovoltaic power generation systems.

### BRIEF DESCRIPTION OF DRAWINGS

FIG. 1 is a schematic view of a base used in a sun-tracking photovoltaic power generation system according to the present invention, the base having a plurality of photovoltaic power generation panels loaded thereon.

FIG. 2 is a schematic view of the base in FIG. 1, where the base is rotated.

FIG. 3 is a perspective view schematically showing an embodiment of the sun-tracking photovoltaic power generation system according to the present invention.

FIG. 4 is a plan view schematically showing an example where the bases with different sizes are arranged for effective use of an installation space.

FIG. 5 is a bottom view showing the base having the photovoltaic power generation panels used in the sun-tracking photovoltaic power generation system according to the present invention and a plurality of rails laid on an undersurface of the base.

FIG. 6 is a plan view of an arrangement example of a plurality of wheels placed on a top surface of a stand used in the sun-tracking photovoltaic power generation system according to the present invention.

FIGS. 7A and 7B are side views of main parts of the rails and the wheels constituting examples of rotating means used in the sun-tracking photovoltaic power generation system according to the present invention.

FIG. 8 is a side view of a main part of the rail and the wheel constituting another example of the rotating means used in the sun-tracking photovoltaic power generation system according to the present invention.

FIG. 9 is a side view of a main part of the rail and the wheel constituting another example of the rotating means used in the sun-tracking photovoltaic power generation system according to the present invention.

FIG. 10A and FIG. 10B are respectively a side view and a plan view of a main part of the rail and a driving wheel constituting driving means used in the sun-tracking photovoltaic power generation system according to the present invention.

FIG. 11 is a perspective view showing an example of wheel supporting means which can adjust the height of a wheel to be supported.

FIGS. 12A, 12B, and 12C are views for describing differences in power generation amount due to differences in incident angles of sunlight entering the photovoltaic power generation panel.

FIGS. 13A and 13B are views for describing the photovoltaic power generation panel being moved to be directly opposite to the sun.

FIG. 14 is a view for describing a shadow generated when the photovoltaic power generation panel follows the direction of the sun in a photovoltaic power generation system of a conventional example.

FIG. 15 is a view for describing a method for eliminating the shadow.

FIG. 16 is a plan view of a base with an elevation/depression angle linking mechanism.

FIG. 17 is a side view for describing the elevation/depression angle linking mechanism.

FIG. 18 is a side view for describing the elevation/depression angle linking mechanism.

FIG. 19 is a side view for describing the elevation/depression angle linking mechanism.

FIG. 20 is a rear view of the photovoltaic power generation panel.

FIG. 21 is a plan view showing another example of the base with the elevation/depression angle linking mechanism.

### DESCRIPTION OF EMBODIMENT

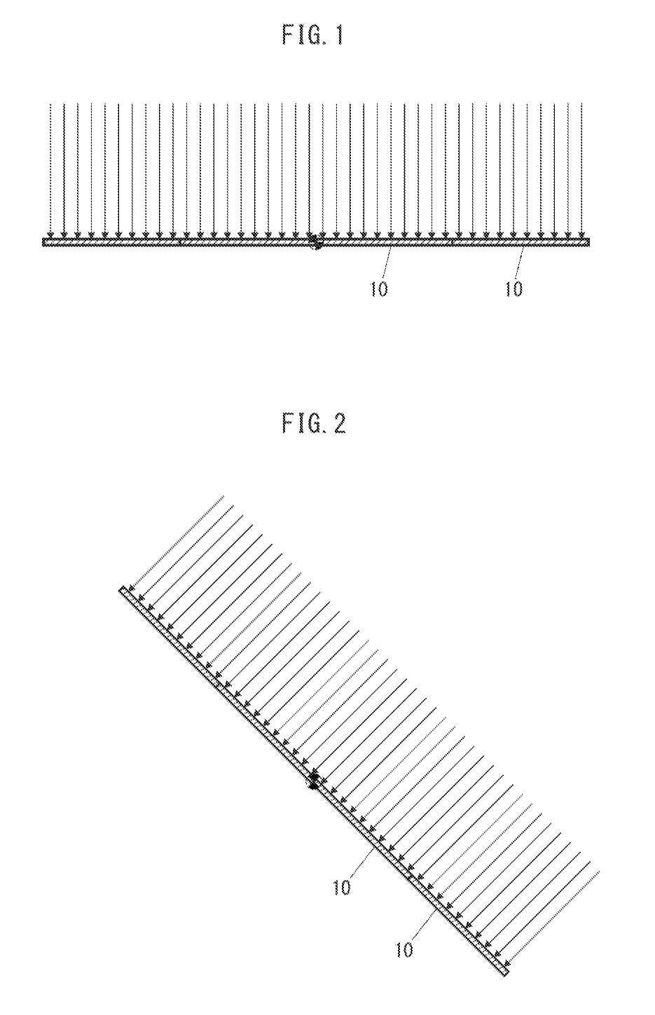

A sun-tracking photovoltaic power generation system according to the present invention is configured to move a base having a plurality of photovoltaic power generation panels 10 closely loaded thereon such that the panels 10 are directly opposite to the sun, as shown in FIG. 1. Accordingly, even when the solar azimuth changes, the energy of the sunlight emitted to surfaces of the photovoltaic power generation panels 10 efficiently enters the panels 10 by the panels 10 tracking the sun such that the panels 10 and the sun are directly opposite to each other as shown in FIG. 2. Further, because the photovoltaic power generation panels 10 can be closely loaded, the power generation amount per unit area can be improved significantly.

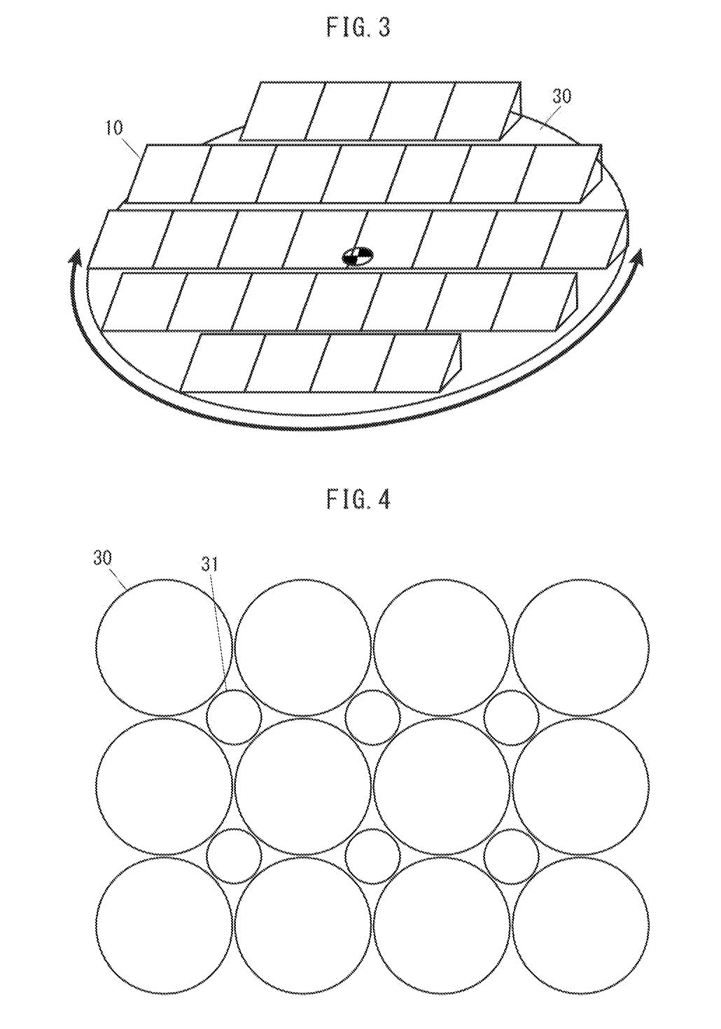

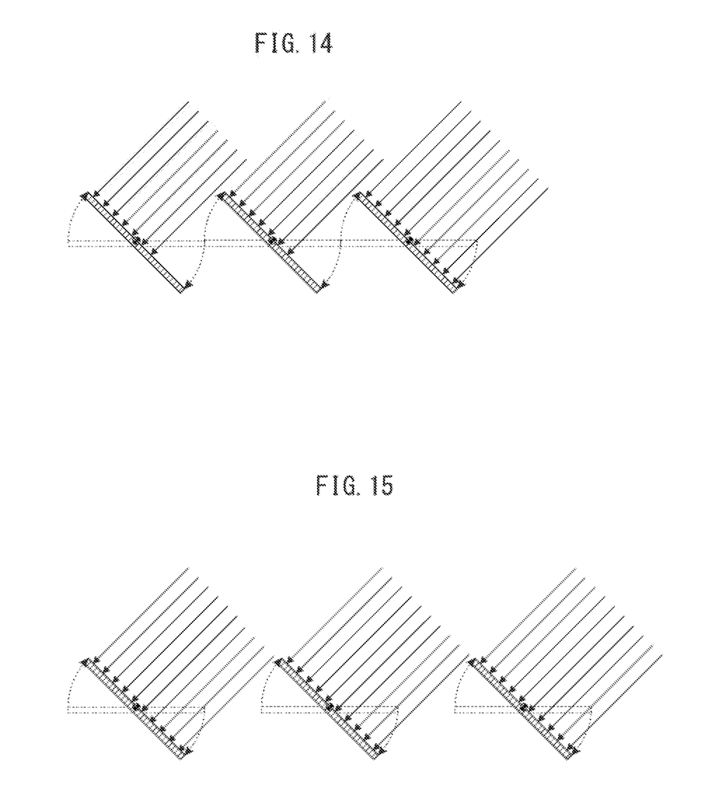

Hereinafter, an embodiment of the sun-tracking photovoltaic power generation system according to the present invention will be shown in FIG. 3 and the configuration and the operational effects will be described. As shown in FIG. 3, the photovoltaic power generation panels 10 are loaded on the base 30 as they are each inclined at a predetermined elevation angle. FIG. 3 is a schematic view and includes 30 photovoltaic power generation panels 10, although actually a larger system may include 200 or more panels 10. Then, at the rotation position of the base 30 corresponding to the sun's culmination position, the photovoltaic power generation panels 10 are loaded on the base 30 as the panels 10 are close to each other in an east-west direction and with a predetermined space therebetween in a north-south direction. The base 30 is configured to be rotationally driven within a horizontal plane, as shown by an arrow, by rotating means to be discussed later. The predetermined elevation angle and predetermined space are set to give the comprehensively highest electric generation efficiency according mainly to a latitude of the installation site. Especially, the predetermined space is selected to minimize the impact of shadow as shown in FIG. 14 considering the size and the latitude of each photovoltaic power generation panel 10. The predetermined elevation angle and predetermined space may differ between a panel and another panel arranged in the preceding or following row.

Thus, the single base 30 having the photovoltaic power generation panels 10 loaded thereon is rotated (track) by one rotating means along with the solar azimuth angle, which reduces the device cost and the energy for tracking in the sun-tracking photovoltaic power generation system and enhances the cost-benefit performance of the entire system.

The base 30 is manufactured to have, for example, a diameter of 30 m and an area of about 700 m², and FIG. 4 shows an example of a large-scale photovoltaic power plant using a plurality of such bases 30. The base 30 is formed in a circular shape because it is rotated horizontally. Accordingly, use of a plurality of bases 30 with only one kind of diameter produces a considerable vacant space among the bases 30. Then, as shown in FIG. 4, by using bases 30 and 31 with different diameters in combination and placing the bases 31 with a diameter of, for example, 12 m within the vacant space, the vacant space can be significantly reduced. In this way, a number of bases can be placed efficiently in a limited installation space. Here, bases with a further smaller diameter may be placed between the plurality of bases 30 with the diameter of 30 m and the base 31 with the diameter of 12 m. The base 31 has a diameter of 4 m when the base 30 has a diameter of 10 m.

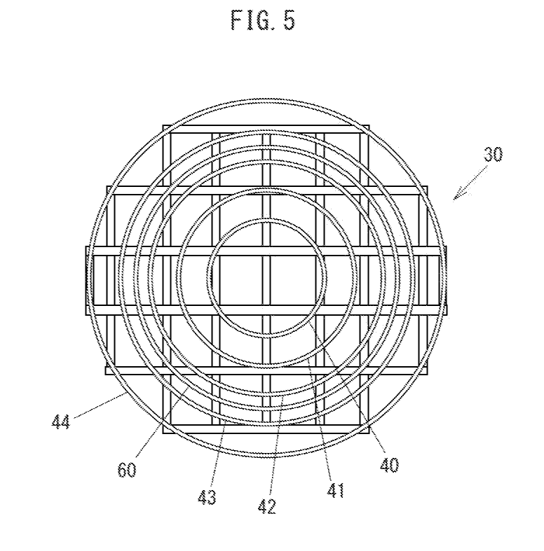

Next, using FIGS. 5 to 11, specific configurations of the base, a stand, and the rotating means will be described as an embodiment of the sun-tracking photovoltaic power generation system according to the present invention. FIG. 5 is a bottom view of the base 30. FIG. 5 shows a configuration example of the base 30 and a plurality of rails 40 to 44 and 60 concentrically provided on an undersurface of the base 30. The base 30 is built in a matrix, as shown in the figure, by connecting beam-shaped structural materials (building structural steel material) of a metal extrusion material or rolled material. Here, FIG. 3 is a schematic view as discussed above, and the base 30 is shown in a disk shape, but actually, the base 30 is configured in a matrix by building the beam-shaped structural materials as in FIG. 5. Examples of the beam-shaped structural materials include an L angle, a C channel, an H steel, an I steel, a square pipe, and a circular pipe.

And, on such a base 30, the plurality of photovoltaic power generation panels 10 are loaded as inclined each at a predetermined elevation angle by, for example, a support set up from the beam-shaped structural materials. The rails 40 to 44 are concentrically laid on the undersurface of the base 30 and fixed to the base 30, while reinforcing the matrix-shaped base 30. Any rotating shaft member is not provided to the rotation center of the base 30.

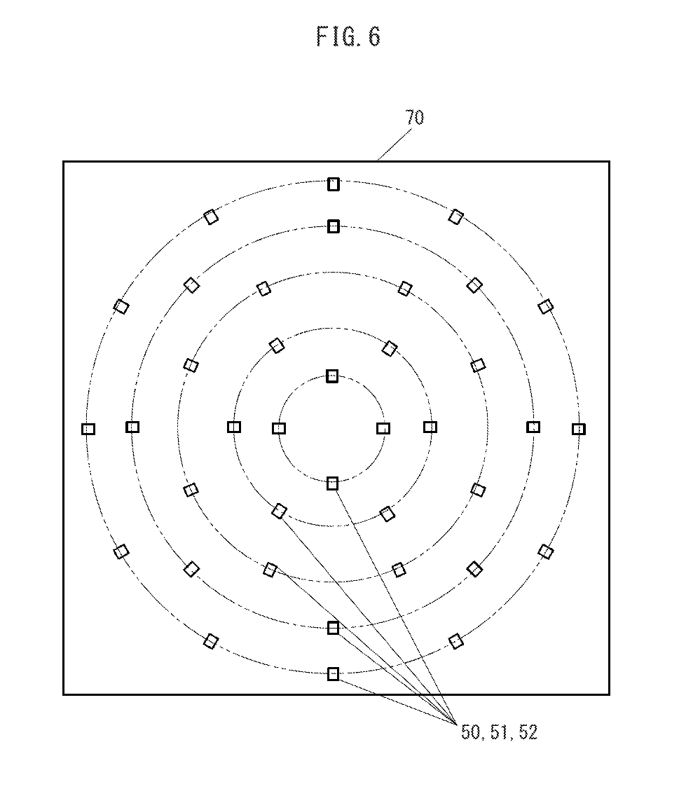

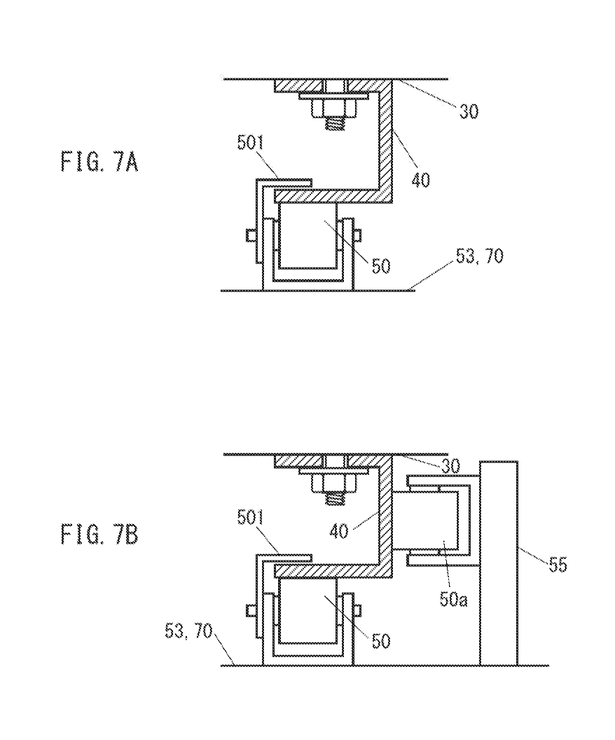

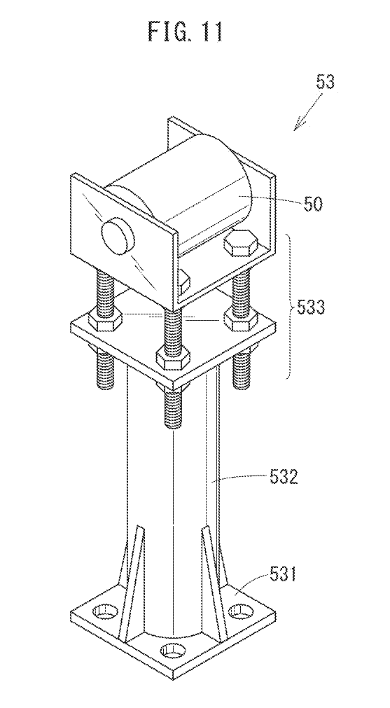

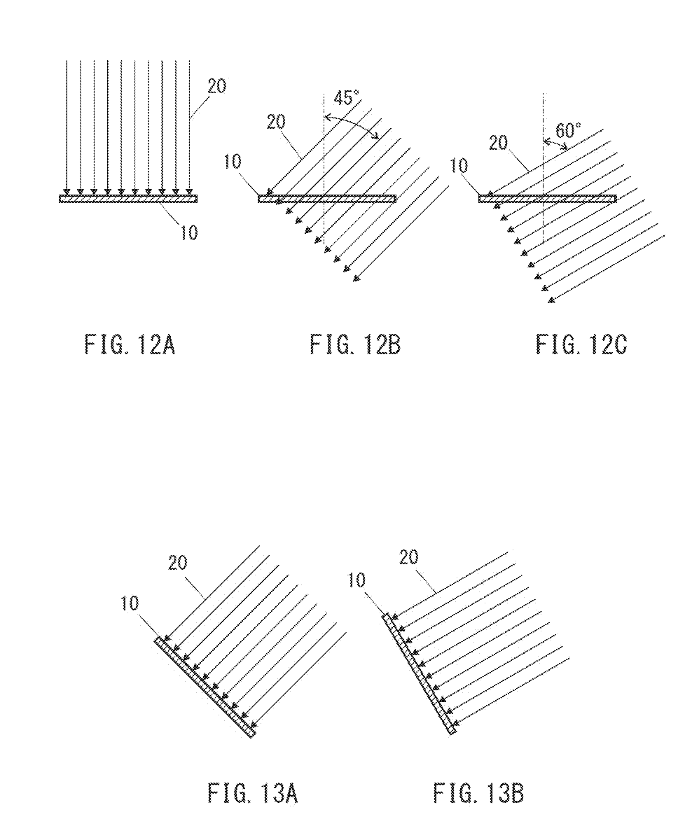

FIG. 6 is a plan view of an arrangement state of a plurality of wheels 50 to 52 placed on the stand 70. The wheels 50 to 52 are placed on a horizontal plane along the above concentric rails 40 to 44 shown by a chain double-dashed line. The horizontal plane is formed on the stand 70 or wheel supporting means 53 by the wheels 50 to 52 shown in FIGS. 7A, 8, and 9, and achieved by installing the wheels 50 to 52 such that they are arranged to the same height and their shafts are horizontal. FIG. 11 is a perspective view showing an example of the wheel supporting means 53. The wheel supporting means 53 is provided to stand on the foundations for the wheels 50 to 52 supported by a top surface of the means 53 to be arranged to the same height and to have their shafts supported horizontally.

Functions achieved by the wheels 50 to 52 and the rails 40 to 44 include a load bearing function to bear the load of the base 30, a wheel detachment preventing function to prevent the rails 40 to 44 from detaching from the wheels 50 to 52, and a lifting preventing function to prevent the rails 40 to 44 from being lifted from the wheels 50 to 52.

The load bearing function can be achieved by the configuration of the rail 40 for load bearing and the wheel 50 configured to contact a bottom surface of the rail 40 and roll under the load, as shown in FIG. 7A. The number of the wheels 50 for achieving the load bearing function can be increased and decreased in accordance with the weight of the base 30. Such wheel 50 achieving the load bearing function is configured to bear the load of the base 30 and to rotate lightly with a little resistance as a wheel for a rotational movement of the base 30 about the rotation center of the base 30. That is, a rotating shaft of the wheel 50 is arranged in a radial direction of concentric circles of the rails 40 to 44.

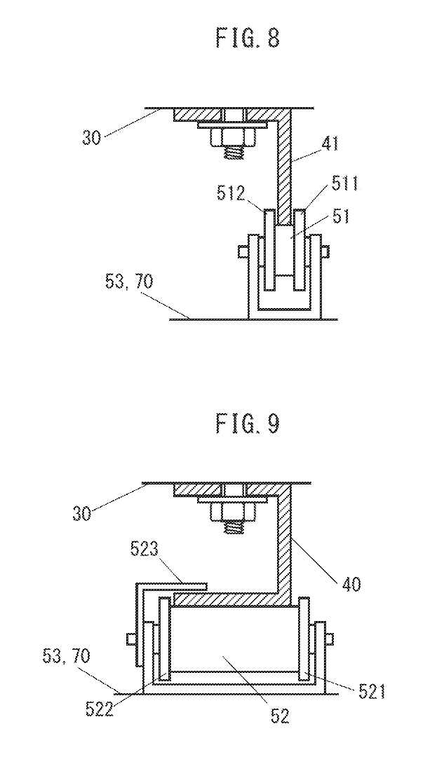

The wheel detachment preventing function can be achieved by regulating means placed in proximity of side surfaces of the rail 41 and regulating side-to-side run out of the rail 41. As the regulating means, the wheel 51 may be provided with flanges 511 and 512 as in shown FIG. 8 or the rail 41 may be provided with a guide. Such wheel 51 achieving the wheel detachment preventing function prevents the rail 41 from detaching from the wheel 51 by the flanges 511 and 512 provided to sandwich the L angle-shaped rail 41, which bears a stress caused by a force acting in directions except the rotation direction. The rail 41 shown in FIG. 8 functions as a wheel detachment preventing rail as well as functioning as a load bearing rail when bearing a load.

The lifting preventing function is achieved by regulating means placed in proximity of part of a top surface of the rail 40 and regulating upward lifting of the rail 40. The regulating means achieving the lifting preventing function can be achieved by laying the C channel-shaped rail 40 on the undersurface of the base 30 and providing the stand 70 or the wheel supporting means 53 with a lifting preventing body 501 of an inverted L shape covering from above a piece of the C channel-shaped rail 40 opposite to one fixed to the undersurface of the base 30, as shown in FIG. 7A. The lifting preventing body 501 runs to hold the C channel and come around above the rail 40 as described above, and thus, even if the base 30 and the rail 40 are about to lift from the wheel 50 due to, for example, a strong wind and an earthquake, the lifting preventing body 501 can prevent it.

Here, as the plurality of rails 40 to 44, those having the configuration of the rail 40 shown in FIG. 7A and those having the configuration of the rail 41 shown in FIG. 8 can be used in combination. Although FIG. 7A and FIG. 8 show examples of using the rails 40 and 41 with two types of shapes, the shape does not need to be limited as long as the above three objects (load bearing function, wheel detachment preventing function, and lifting preventing function) are achieved. For example, the three objects can be obtained by one type of rail 40 and a wheel 52 as shown in FIG. 9, or by one type of rail 40 and two wheels 50 and 50a as shown in FIG. 7B.

In the example in FIG. 9, a lifting preventing body 523 is provided, and also, the wheel 52 not only bears the load, but also prevents wheel detachment by having flanges 521 and 522 provided on both ends thereof. In the example in FIG. 7B, any special wheel with flanges is not used, but a wheel 50a similar to the wheel 50 is supported by a support 55 provided to stand from the stand 70 or the wheel supporting means 53 such that a rotating shaft of the wheel 50a is vertical. Then, the wheel 50a rolls on an outer circumferential surface of the C channel-shaped rail 40, thereby preventing wheel detachment with inexpensive parts.

In this way, the base 30 is supported by a number of wheels 50 to 52 fixed on the stand 70 or the wheel supporting means 53 and the plurality of rails 40 to 44 fixed on the undersurface of the base 30. As a result, the base 30 which weighs a significant amount with a number of photovoltaic power generation panels 10 loaded thereon can be stably supported and rotated with a small resistance. Moreover, because the base 30 having the photovoltaic power generation panels 10 loaded thereon is provided with the rails 40 to 44 and the stand 70 or the wheel supporting means 53, which are closer to the ground, is provided with the wheels 50 to 52 in the sun-tracking photovoltaic power generation system of the embodiment, it is easier to support the wheels 50 to 52 on the same horizontal plane than laying the rails 40 to 44 horizontally on a large installation space. This can reduce the construction cost and shorten the construction period, thereby facilitating the spread of large-scale sun-tracking photovoltaic power generation systems. Also, provision of the lifting preventing bodies 501 and 523 and the flanges 511, 512, 521, and 522 prevents a problem of the rails 40 to 44 coming off the wheels 50 to 52 due to a strong wind such as a typhoon and an earthquake.

Further, because the base 30 is reinforced concentrically by the plurality of rails 40 to 44, that is, the rails 40 to 44 partly form the base 30, the base 30 itself does not need to be made of highly stiff metal materials but can be made by connecting metal L angles, H steels, and the like in a matrix. Accordingly, a base with a large area can be made light weight at a low cost. For example, a system with a base 30 of 30 m or more in diameter and a generated output of 50 kw or more, which is very large not like conventional ones, can be achieved at a low cost. This is largely because the reinforcement of the base 30 by the rails 40 to 44 reduces the total weight of the rotating body of the photovoltaic power generation panels 10 with the base 30 to around 20 t. Furthermore, even with such a large base 30, the energy (power consumption) for tracking can be kept as particularly low as less than 10 w on average because of the light weight.

The value 50 kw equals to as many as 10 times the generated output 5 kw of a photovoltaic power generation device installed at an ordinary household in Japan, and as many as 16 times the power consumption 3 kw of the ordinary household. Also, a photovoltaic power generation device of fixed type generates power exceeding 90% of that at the peak for about three hours, whereas a sun-tracking photovoltaic power generation device like in the present invention generates power exceeding 90% of that at the peak for six hours or more if it tracks the sun even at around the spring and autumn equinoxes, when the difference between the two less likely to occur. Especially, in summer, we have longer hours of sunlight and also the sun rises and sets in more northern latitudes, and thus this increases the tracking effect. As a result, the sun-tracking photovoltaic power generation device presumably generates power of 90% or more of that at the peak for nearly nine hours. Specifically, in the case of a fixed-type solar panel installed facing south, the sun sometimes moves around to the back side of the panel in the mornings and evenings in summer, but if the device tracks the sun as in the present invention, the device can have sunlight enter the panel surface throughout a day. As described above, the sun-tracking photovoltaic power generation device having longer effective power generation hours than the fixed type device is high in quality as a power source, and the present invention, which can extremely upsize such a sun-tracking photovoltaic power generation device at a low cost, has remarkable superiority.

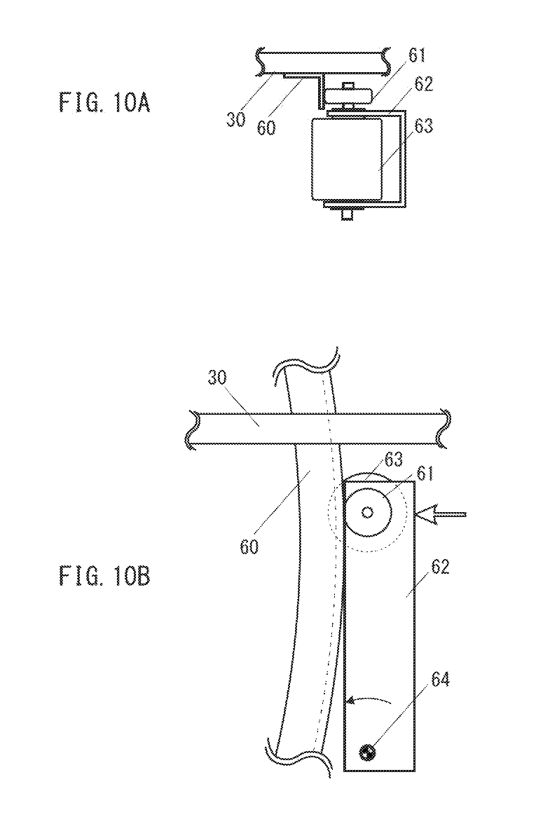

Next, a description will be given about an example of driving means for tracking the sun in the sun-tracking photovoltaic power generation system according to the present invention. FIGS. 10A and 10B are views for describing the example of the driving means, where FIG. 10A is a side view and FIG. 10B is a plan view. In general, the driving means achieves a driving function in such a manner that a driving wheel 61 is pressed against the rail 60 attached to the undersurface of the base 30 and functioning as a driven wheel, and the driving wheel 61 is driven by a motor 63. The rail 60 is formed by an L angle curved into an arc shape. The driving wheel 61 is made from a material which hardly slides against the rail 60 such as a rubber. For further friction against the rail 60, if necessary, the rail 60 may be provided with a rack while knurling the driving wheel 61, for example.

The motor 63 is held by one end of an arm 62, and the other end of the arm 62 is supported on the stand 70 by a pin 64 such that the arm 62 is swingable about a vertical axis. Then, the arm 62 is configured to press the motor 63, that is, the driving wheel 61 against a side surface of the rail 60 with a predetermined pressure by biasing means (not shown) such as a spring. In this way, rotation of the motor 63 rotates the base 30, allowing the base 30 to track changes of the solar azimuth. It is to be noted that the rail 60 is formed by an L angle in the example above, but may be such that the rail 60 is formed by a belt-shaped plate laid on the undersurface of the base 30, on which the driving wheel 61 rotates about a horizontal axis. Also, the rail 60 does not have to be formed in a circle, that is, an endless circle, and may be formed in an arc extending to a necessary range for tracking. Further, the rail 60 may also serve as the rails 40 and 41. Furthermore, a belt, a rack belt, and the like may be used for rotating the base 30.

Here, when the rail 60 has a diameter of Dm1 and the driving wheel 61 has a diameter of Dm2, the reduction ratio is Dm1/Dm2, which means a large reduction ratio can be obtained, and the torque of the motor 63 is Dm2/Dm1, which means even a small motor can rotate a large base 30. For example, the base 30 with a diameter of 30 m as described above can be rotated with a small power with an average power of about 10 w.

Next, a description will be given about main part of a method of constructing the system according to the present invention. When carrying out the present invention, first foundations and pavement of, for example, concrete or asphalt are constructed on the ground of an installation site and the stand 70 is formed, the wheel supporting means 53 are positioned on the stand 70, and wheels 50 to 52 are placed on the wheel supporting means 53. As shown in FIG. 6, these wheels 50 to 52 are placed corresponding to the circular rails 40 to 44 on the base 30 along the circumference and adjusted by height adjusting means of the wheel supporting means 53 so that the wheels 50 to 52 have uniform heights and horizontal rotating shafts.

FIG. 11 shows an example of the wheel supporting means 53. The wheel supporting means 53 has a fixing plate 531 to be fixed on the stand 70 using, for example, an anchor bolt at a lower part, the height adjusting means 533 to support the wheels 50 to 52 (reference numeral 50 in the example in FIG. 11) at an upper part, and a support 532 of an appropriate height between the fixing plate 531 and the height adjusting means 533. The height adjusting means 533 can make a fine adjustment of the height by combining bolts and nuts as shown in FIG. 11.

The process of finely adjusting the wheels 50 to 52 to have their top surfaces at an identical height with satisfactory accuracy can be performed easily and quickly by using such wheel supporting means 53 for supporting each of the wheels 50 to 52 and adjusting the height adjusting means 533. It is to be noted that the height adjusting means 533 can also be achieved by interposing a spacer or the like between brackets of the wheels 50 to 52 and the support 532. Alternatively, when a surface of the stand 70 is constructed into a horizontal plane with satisfactory accuracy, the wheels 50 to 52 may be directly fixed on a top surface of the stand 70. These wheels 50 to 52 are placed such that their rotating shafts are horizontal and extended lines of the rotating shafts intersect with each other at the center of the concentric circle. It is to be noted that any central shaft member is not provided at the center of the concentric circle.

Here, a description will be made on an example of simple construction applicable when the ground of an installation site is rock or solid ground in an arid region, or when the base 30 is not large like the one above with a diameter of 30 m but is of a middle to small size. In brief, the simple construction means mounting the fixing plate 531 and the support 532 of the wheel supporting means 53 positioned lower than the height adjusting means 533 on the foundations buried in the unleveled ground as the stand 70 of, for example, concrete or asphalt. To be specific, the foundations include, for example, a pipe (spiral pile) with a spiral circumferential surface screwed into the ground and a block-shaped concrete foundation, which is, after digging out the ground, embedded and then buried within the ground. In this way, the foundations are constructed only on points where the wheels 50 to 52 are supported to eliminate foundation construction from the other area of the installation site, thereby considerably reducing the construction cost.

As has been described, the sun-tracking photovoltaic power generation system of the embodiment follows changes of the solar azimuth angle. The sun-tracking photovoltaic power generation system preferably has an elevation/depression angle linking mechanism which can change the elevation/depression angle of the photovoltaic power generation panel 10 along with the solar altitude (elevation angle) changing as time proceeds from sunrise to sunset. In this case, the elevation/depression angle of the photovoltaic power generation panel 10 can be changed with a dedicated actuator such as a motor or, alternatively, can be changed (in an interlocked manner) using rotation of the base 30 following the change of the azimuth angle.

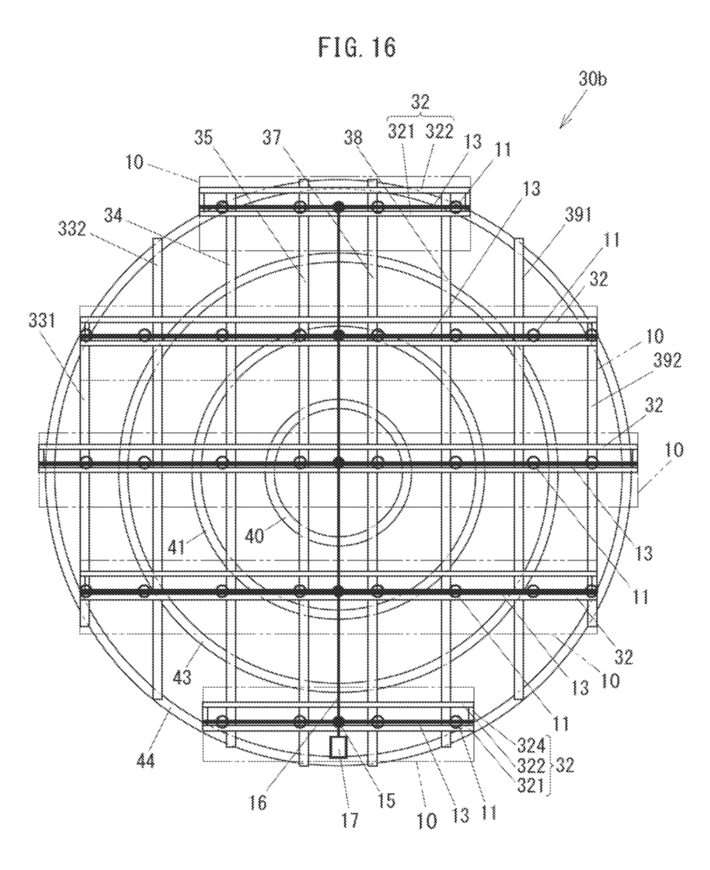

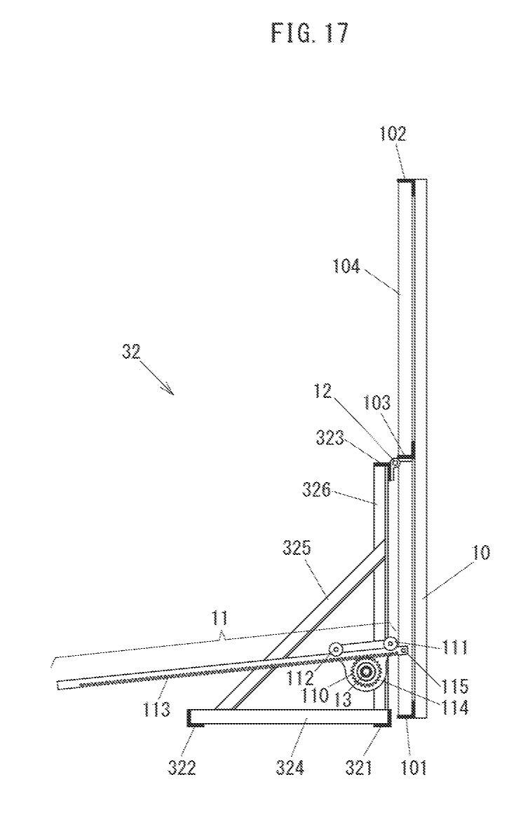

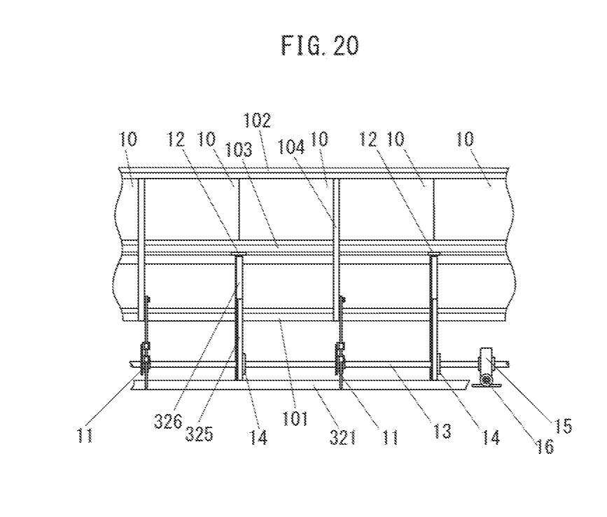

FIG. 16 is a plan view of a base 30b with the elevation/depression angle linking mechanism. FIGS. 17 to 19 are side views for describing the elevation/depression angle linking mechanism. FIG. 20 is a rear view of the photovoltaic power generation panel 10. In FIG. 16, parts with configurations similar to and corresponding to those of FIG. 5 will be given the same reference characters and their explanations will be omitted. In the base 30b, four structural materials 34, 35, 37, and 38 are provided for beam-shaped structural materials extending in the north-south direction, close to the middle in the east-west direction, and two structural materials 331 and 332, and 391 and 392 are respectively provided for westernmost and easternmost beam-shaped structural materials extending in the north-south direction. On the other hand, there is not provided any beam-shaped structural material extending in the east-west direction.

Here, as shown in FIG. 3, when the photovoltaic power generation panels 10 are formed in a strip shape (longitudinal shape) and supported by a frame with a predetermined rigidity, the longitudinal frame material of the strip can be used as part of the beam-shaped structural materials, and the present invention adopts such a configuration. FIG. 3 shows an example where four, seven, eight, seven, four photovoltaic power generation panels 10 are each connected with each other into a unit or a module. The units extend in the east-west direction and are arranged in rows, five rows as described above in the example of FIG. 3, with a predetermined interval in the north-south direction. When a larger substrate can be used for production of the photovoltaic power generation panel 10, the strip may be formed with fewer or one panel.

Then, as described above, an undersurface of the strip-shaped (longitudinal) photovoltaic power generation panel 10 is mounted on and supported by three frames extending in the east-west (longitudinal) direction of frames 101 and 102 on opposite sides of the strip and a frame 103 at the middle of the strip, and transverse frames 104 provided at appropriate positions in the north-south (lateral) direction. Rotation supporting means 12 is provided on the middle frame 103, that is, at an appropriate position generally at the center of gravity of the photovoltaic power generation panel 10, and the rotation supporting means 12 rotates the photovoltaic power generation panel 10 about a horizontal axis, thereby enabling the panel 10 to change its elevation/depression angle.

On the other hand, the elevation/depression angle linking mechanism is configured to include a frame 32, a rack & pinion part 11, the rotation supporting means 12, an interlocking shaft 13, a gearbox 15, a drive shaft 16, and a geared motor 17.

The frame 32 is configured to include three beam-shaped structural materials 321 to 323 extending in the east-west direction, a plurality of supports 326 extending vertically, a plurality of transverse materials 324 extending in the north-south direction, and one or a plurality of reinforcing materials 325, and to form a leg of the photovoltaic power generation panel 10. FIGS. 17 to 19 are side views of the frame 32 and the photovoltaic power generation panel 10 as seen from the west. In the frame 32, the second structural material 322 is positioned as shifted in the south or north (north in the Northern Hemisphere) direction relative to the first structural material 321 by the transverse materials 324, the third structural material 323 is positioned as shifted upward relative to the first structural material 321 by the supports 326, and the supports 326 and the transverse materials 324 are reinforced between them by the oblique reinforcing materials 325. The upper third structural material 323 swingably supports, via the rotation supporting means 12, the photovoltaic power generation panel on an undersurface at an approximate middle point in the width direction (generally the center of gravity). Accordingly, the inclination (elevation angle) of the photovoltaic power generation panel 10 can be adjusted with a small amount of force. In the embodiment, the structural materials 321 to 323, the supports 326, the transverse materials 324, and the reinforcing materials 325 are formed with L angles.

Also, the rack & pinion part 11 and the interlocking shaft 13 are provided in addition to the rotation supporting means 12 for adjusting the inclination (elevation angle) of each unit of the photovoltaic power generation panel 10. The interlocking shaft 13 is a shaft extending in the east-west direction on the undersurface of the photovoltaic power generation panel 10 as shown in FIG. 16, and rotatably supported by the supports 326 in proximity of their lower ends via bearings 14 as shown in FIG. 20. The rack & pinion part 11 is provided at appropriate points of the interlocking shaft 13. In the example of FIG. 16, the rack & pinion part 11 is provided at four points of the interlocking shafts 13 corresponding to the short northernmost and southernmost photovoltaic power generation panels 10 and at eight points of the interlocking shafts 13 corresponding to the long photovoltaic power generation panels 10 between them.

The rack & pinion part 11 is configured to include a base 114, a pinion gear 110, receiver rollers 111 and 112, and a rack gear 113. The interlocking shaft 13 is inserted into and supported by the base 114, and the base 114 is rotatable in the circumferential direction of the interlocking shaft 13. The pinion gear 110 is firmly fixed to the interlocking shaft 13. The pair of receiver rollers 111 and 112 is provided on the base 114 such that the rollers 111 and 112 are opposed to the pinion gear 110. The rollers 111 and 112 have a cross section of one diameter line of approximately 1 shape or H shape, and hold the rack gear 113 at the side opposite to a gear surface with the 1 shape or a groove of the H shape. The gear surface of the rack gear 113 engages with the pinion gear 110. The rack gear 113 is swingably connected at one end to the photovoltaic power generation panel 10 in proximity of a lower end of the panel 10 by a pin 115.

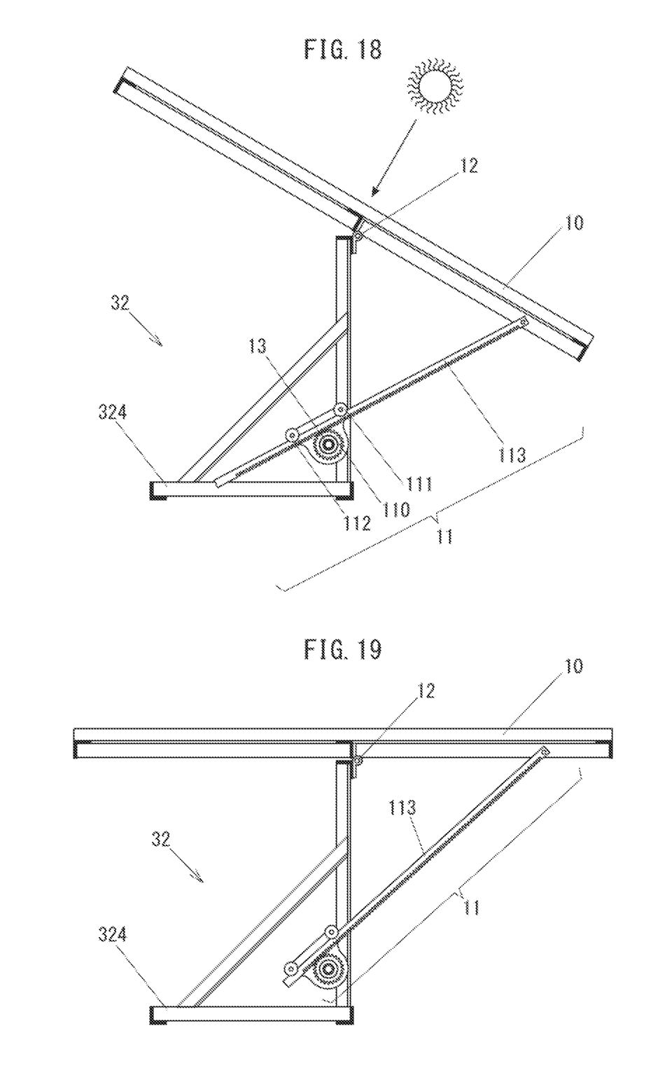

Accordingly, the plurality of pinion gears 110 firmly fixed to the interlocking shaft 13 rotates in conjunction with the rotation of the interlocking shaft 13, thereby extending or drawing the rack gear 113 engaging with the pinion gear 110. Thus, when the rack gear 113 is fully drawn, the photovoltaic power generation panel 10 is in a standing state with a maximum elevation angle as shown in FIG. 17, when the rack gear 113 is extended, the elevation angle of the photovoltaic power generation panel 10 is reduced as shown in FIG. 18, and when the rack gear 113 is fully extended, the photovoltaic power generation panel 10 is in a horizontal state with a minimum elevation angle as shown in FIG. 19.

Referring to FIG. 16, each interlocking shaft 13 is rotationally driven by the common drive shaft 16 via the gearbox 15. The drive shaft 16 is rotationally driven by the geared motor 17. In this way, by driving the geared motor 17 along with the solar altitude from sunrise to sunset, the elevation angle of the photovoltaic power generation panel 10 can be controlled collectively such that the photovoltaic power generation panel 10 is always directly opposite to the sun. In this regard, the approximate middle (center of gravity) of the photovoltaic power generation panel 10 is swingably supported by the rotation supporting means 12 as described above, and at the same time, the elevation angles of a number of photovoltaic power generation panels 10 can be adjusted collectively by a low torque with the geared motor 17, gearbox 15, and the gear ratio of the rack & pinion part 11.

Then, the three structural materials 321 to 323, which are a frame to support a unit of the photovoltaic power generation panel 10, are used as the east-west beam-shaped structural materials forming the base 30b, combined in a matrix with the north-south beam-shaped structural materials 331 and 332; 34, 35, 37, and 38; and 391 and 392 forming the base main body, and further reinforced by the concentric rails 40, 41, 43, and 44, thereby constituting the base 30b. As constituted in this way, the base 30b can further reduce the number of structural materials while ensuring a predetermined strength.

In addition, the base 30b is not provided with the drive rail 60, and the outermost rail 44 is also used as a drive rail. Then, the wheel 50 shown in FIG. 7A provided at a plurality of points substantially evenly spaced from each other in the circumferential direction of the rail 44 functions as a drive wheel as well as bearing the load. Also, the wheel 50a shown in FIG. 7B provided at a plurality of points substantially evenly spaced from each other in the circumferential direction is used for the position regulation in the circumferential direction of the base 30b, namely, derailment prevention. The number of wheels 50 and 50a may be set according to the size of the base 30b, and the functions of drive and wheel detachment prevention may be assigned to any rail.

Here, because the earth's axis of rotation is tilted by about 23.4 degrees, the culmination altitude of the summer solstice at 35 degrees north latitude is 78.4 degrees, and the elevation angle of the photovoltaic power generation panel 10 directly opposite to the sun is 11.6 degrees. As a result, the elevation angle of the photovoltaic power generation panel 10 needs to be greatly changed as 90 degrees at sunrise, 11.6 degrees at culmination, and 90 degrees at sunset, so that the elevation/depression angle linking mechanism as described above is preferably used. On the other hand, because the shadow is long when the solar altitude is low, if there is another base 30b on the north and/or the east and west sides of the base, the elevation angles at sunrise and sunset may be set in accordance with, for example, the space between the photovoltaic power generation panels 10 in the north-south direction. For example, the elevation angle is set to 5 degrees from sunrise until the solar altitude reaches 30 degrees and from the solar altitude of 30 degrees until sunset.

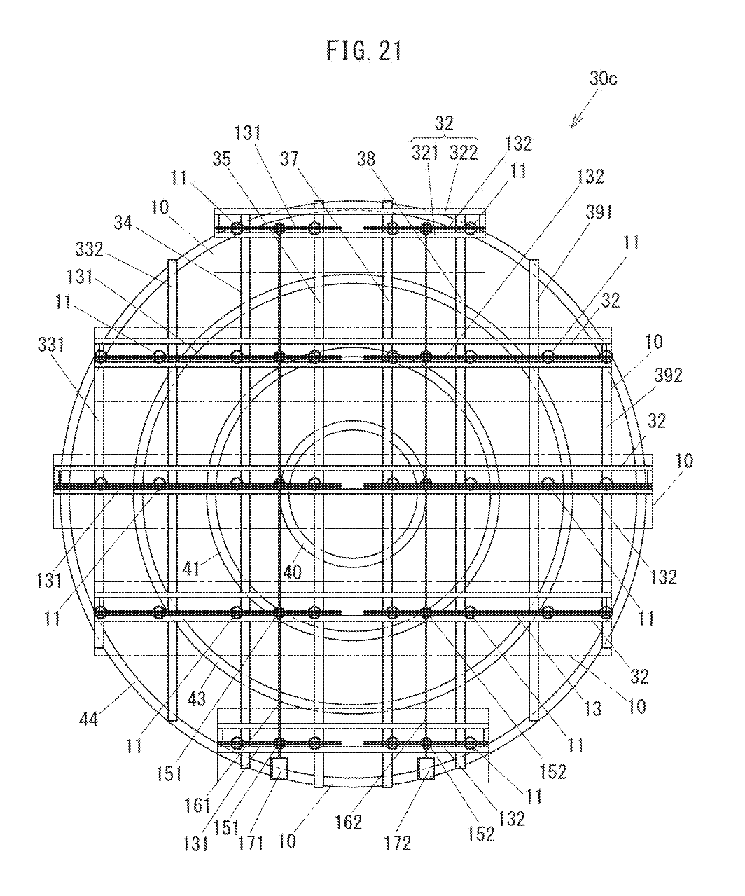

By the way, the photovoltaic power generation panel 10 undergoes wind pressure. In this case, the gearbox 15 where the rotating shafts intersect at right angles mainly receives the stress caused by the wind pressure. Therefore, the gearbox 15 may be sized and configured to have a strength to withstand stress caused by, for example, a string wind at rest, not a strength for operation. Also, when the base 30b is upsized or installed in windy areas, interlocking shafts 131 and 132, gearboxes 151 and 152, drive shafts 161 and 162, and geared motors 171 and 172 may be divided into a plurality of systems as shown by a base 30c in FIG. 21. In the example of FIG. 21, they are divided into two systems. Thus, the photovoltaic power generation panel 10 can be improved in resistance to, for example, a strong wind.

Here, the azimuth angle and the elevation/depression angle may be adjusted such that first calculating in advance the azimuth and the altitude of the sun for each time of a year or each date and time by calculating means to store the data in storage means, and then, using a calendar function by a control device such as a microcomputer controlling the motor 63 and the like, retrieving the data corresponding to the date and time of the day to control the motor 63 and the like. The azimuth angle and the elevation/depression angle may also be calculated every day and every time.

The elevation/depression angle linking mechanism as shown in FIGS. 16 to 21 can be used as laying means and standing means by extending the range of motion. The laying means supports the photovoltaic power generation panel 10 as laid in a substantially horizontal state as shown in FIG. 19, and the standing means supports the photovoltaic power generation panel 10 as erected in a substantially standing state as shown in FIG. 17. These laying means and standing means can be operated, for example, when the geared motor(s) 17, or 171 and 172 receiving a laying control signal or a standing control signal from an external control device, and the like.

For example, the laying control signal is generated when observing a strong wind exceeding a predetermined threshold value from wind velocity data obtained by an anemometer installed close to the photovoltaic power generation panel 10 or within the premise of the sun-tracking photovoltaic power generation system, or by a weather information system. This prevents, in such a case, the wheels 50 to 52 from detaching from the rails 40 to 44 or the photovoltaic power generation panel 10 from being damaged under the influence of the wind pressure by laying the photovoltaic power generation panel 10 into a substantially horizontal state, and also eliminates the need to excessively improve the strength of the structural materials for the base 30c or for loading the photovoltaic power generation panel 10 on the base 30c, thereby keeping low the cost of the structural materials. It is to be noted that the wind velocity data is not limited to actual observation values, and may be predicted values in the case of typhoon and the like. Also, the threshold value may be set low during morning and evening hours and at night, when the power generation amount is scarce, for further prevention of the problem as above.

On the other hand, the standing control signal is generated when, for example, snowfall or fall of volcanic ash is detected or predicted. This prevents, in such a case, reduction of the electric generation efficiency or power generation failure due to the snowfall or the ash fall by leaving the photovoltaic power generation panel 10 in a substantially standing state, and also prevents the photovoltaic power generation panel 10 from being damaged due to the weight of snow or ash.

It is to be noted that the laying means and the standing means may be achieved with an independent dedicated configuration without being used also as the elevation/depression angle linking mechanism.

### INDUSTRIAL APPLICABILITY

The sun-tracking photovoltaic power generation system according to the present invention can achieve a configuration capable of tracking the solar azimuth angle in a large scale and at a low cost, contributing to the spread of photovoltaic power generation.

1. A sun-tracking photovoltaic power generation system configured to rotate by rotating means a base having a plurality of photovoltaic power generation panels loaded thereon closely to each other such that the photovoltaic power generation panels are directly opposite to the sun at flat surfaces,
the rotating means comprising:
a plurality of rails to be laid concentrically on an undersurface of the base having the photovoltaic power generation panels loaded thereon;
a plurality of wheels on which the rails are to be placed and supported;
wheel supporting means for supporting the wheels on a stand provided at an installation site; and
driving means for rotating the base on the wheels,
the base being composed of combined beam-shaped structural materials and concentrically reinforced by the plurality of rails.

2. The sun-tracking photovoltaic power generation system according to claim 1, wherein
the photovoltaic power generation panels are formed in a strip shape and supported by a frame with a predetermined rigidity,
the strip of the photovoltaic power generation panels is loaded on the base in an east-west direction at a rotating point of the base corresponding to a culmination position of the sun, and
the base includes:
a base main body consisting of the beam-shaped structural materials extending in a north-south direction,
the frame used as the beam-shaped structural materials extending in the east-west direction, and
the concentric rails.

3. The sun-tracking photovoltaic power generation system according to claim 2, further comprising an elevation/depression angle linking mechanism for changing an elevation/depression angle of the photovoltaic power generation panel loaded thereon along with an solar altitude.

4. The sun-tracking photovoltaic power generation system according to claim 3, wherein, in the elevation/depression angle linking mechanism, the east-west beam-shaped structural materials of the frame functioning as a leg of the photovoltaic power generation panel are combined with the base main body consisting of the north-south beam-shaped structural materials and the concentric rails.

5. The sun-tracking photovoltaic power generation system according to claim 4, wherein the leg includes three beam-shaped structural materials extending in the east-west direction, a plurality of supports extending vertically, a plurality of transverse materials extending in the north-south direction, and one or a plurality of reinforcing materials,
the second structural material is placed as shifted in the south or north direction relative to the first structural material by the transverse materials, the third structural material is placed as shifted upward relative to the first structural material by the supports, and the supports and the transverse materials are reinforced between them by oblique reinforcing materials,
the third structural material swingably supports the strip-shaped photovoltaic power generation panel on an undersurface at an approximate middle point in a width direction via rotation supporting means.

6. The sun-tracking photovoltaic power generation system according to claim 5, wherein a pinion gear is provided in proximity of a lower end of the support, a rack gear is swingably connected at one end to the photovoltaic power generation panel in proximity of a lower end of the panel, and extension of the rack gear by rotation of the pinion gear increases an elevation angle of the photovoltaic power generation panel.

7. The sun-tracking photovoltaic power generation system according to claim 6, wherein the pinion gear and the rack gear are provided at a plurality of points on the undersurface of the photovoltaic power generation panel,
the plurality of pinion gears are rotated as interlocked with each other by an interlocking shaft,
the interlocking shaft is rotationally driven by a drive shaft via a gearbox, and
the gearbox receives a stress caused by wind pressure received by the photovoltaic power generation panel.

8. The sun-tracking photovoltaic power generation system according to claim 7, wherein the interlocking shaft, the gearbox, and the drive shaft are divided into a plurality of systems.

9. The sun-tracking photovoltaic power generation system according to claim 1, wherein the plurality of rails laid concentrically include two types of rails of a load bearing rail configured to bear a weight of the base and a wheel detachment preventing rail for preventing detachment of the wheels.

10. The sun-tracking photovoltaic power generation system according to claim 1, further comprising a control device for causing the rotating means to rotate the base such that an azimuth of the photovoltaic power generation panel matches with a solar azimuth calculated by calculating means.

11. The sun-tracking photovoltaic power generation system according to claim 3, further comprising a control device for driving the elevation/depression angle linking mechanism such that the elevation/depression angle of the photovoltaic power generation panel matches with a solar altitude calculated by the calculating means.

12. The sun-tracking photovoltaic power generation system according to claim 11, wherein, upon receiving a laying control signal from outside, the control device causes the elevation/depression angle linking mechanism to function as laying means to bring the photovoltaic power generation panel into a lying state where the panel is laid substantially flat.

13. The sun-tracking photovoltaic power generation system according to claim 11, wherein, upon receiving a standing control signal from outside, the control device causes the elevation/depression angle linking mechanism to function as standing means to erect the photovoltaic power generation panel into a substantially standing state.
